(19) United States
(12) Patent Application Publication
(10) Pub. No.: US 2022/0243646 A1
(43) Pub. Date: Aug. 4, 2022

(54) CHARGED SERIAL HYBRID COMBUSTION ENGINE

(71) Applicant: MAGNA INTERNATIONAL INC., Aurora (CA)

(72) Inventors: Christoph HOEFER, Hargelsberg (AT); Gerd SCHLAGER, St. Valentin (AT)

(21) Appl. No.: 17/616,247

(22) PCT Filed: Jun. 5, 2020
(86) PCT No.: PCT/CA2020/050779

§ 371 Date: Dec. 3, 2021

Related U.S. Application Data
(60) Provisional application No. 62/857,962, filed on Jun. 6, 2019.

(51) Int. Cl. F02B 33/40; F02B 67/10; F16F 15/20; F16F 15/26; B60K 6/24; B60K 6/42; B60K 13/02; B60K 6/30

(52) U.S. Cl. CPC F02B 33/40; F02B 67/10; F16F 15/20; B60K 6/30; B60K 6/24; B60K 6/42; B60K 13/02; F16F 15/264

(57) ABSTRACT

A system for providing power to a vehicle includes a combustion engine having a low number of cylinders. A mechanically driven charging mechanism is attached to the combustion engine to provide pressurized air to the combustion engine and generate increased power. The combustion engine includes a 2nd order mass balance shaft that is operatively coupled to a crankshaft of the engine. The 2nd order mass balance shaft rotates at a higher speed than the crankshaft and counters inertial forces generated by the pistons of the engine. A compressor of the mechanically driven charging mechanism is attached to the 2nd order mass balance shaft, such that the mechanically driven charging mechanism is mechanically driven by rotation of the 2nd order mass balance shaft. The high speed of the 2nd order mass balance shaft drives the compressor of the mechanically driven charging mechanism.

### CROSS REFERENCE TO RELATED APPLICATIONS

This PCT International Patent application claims the benefit of and priority to U.S. Provisional Patent Application Ser. No. 62/857,962, filed Jun. 6, 2019, titled “Charged Serial Hybrid Combustion Engine,” the entire disclosures of which is hereby incorporated by reference.

### TECHNICAL FIELD

The present disclosure relates to serial hybrid combustion engines. More particularly, the present disclosure relates to a serial hybrid combustion engine with a mechanically driven supercharger.

### BACKGROUND OF THE DISCLOSURE

Hybrid electric vehicles are in common use in the automotive industry. Hybrid electric vehicles are offered in different arrangements. One type of hybrid vehicle is a parallel hybrid vehicle, in which an internal combustion engine and an electric motor are each connected to the vehicle transmission to drive the wheels of the vehicle. Another type of hybrid vehicle is a series hybrid vehicle, which includes an electric motor and a combustion engine, where the wheels are driven directly by the electric motor. In the series hybrid, the electric motor or/and the battery receives power from the combustion engine. More particularly, the combustion engine turns a generator, which powers the motor.

Series hybrids provide advantages, including the ability for the motor to directly drive the wheels, which can eliminate the need for a multi speed transmission and clutch. Accordingly, as the combustion engine is not used to drive the wheels, the combustion engine may be made generally smaller than in parallel hybrids or traditional combustion engine based vehicles. Thus, the reduction in required output from the combustion engine may thereby reduce emissions.

Combustion engines used in a series hybrid may typically have a low number of cylinders, such as one or two cylinders per crankshaft. Internal combustion engines with a specific power of more than 40 kW/L require a “charging” system such as a turbocharger or a supercharger. A turbocharger operates by using energy from the exhaust of the combustion engine to drive a turbine that will provide charged air into the cylinder of the engine. A supercharger, also referred to as a mechanically driven supercharger, is driven by a dedicated drive. The mechanically driven supercharger may be any kind of device that pumps air to a higher input pressure.

Turbo charged engines provide charged air, but have the disadvantage of highly fluctuating mass flow at the turbine, especially in the case of engines with a low number of cylinders, such as engines used in series hybrid vehicles. Turbo charged engines also include feedback from the exhaust. A supercharger is beneficial for internal combustion engines with low cylinders relative to a turbocharger because there is no feedback from the exhaust.

Combustion engines with a low number of cylinders, such as those used in serial hybrids, may also include a first and/or second order mass balancing system. The mass balancing system may be necessary to avoid noise, vibration, and harshness (NVH) issues. The mass balancing system may include a balance shaft that includes eccentric weights that can offset NVH issues for engines that are not inherently balanced. The mass balancing system and the balance shaft thereof is rotated at the twice the speed of the crankshaft, thereby countering the inherent imbalance of the engine.

In view of the above, improvements can be made to the serial hybrid engines for efficiently providing sufficient output power from the engine via a charging system.

### SUMMARY OF THE INVENTION

In one aspect, a system for providing power to a vehicle is provided, the system comprising: a combustion engine having a cylinder and a piston coupled to a crankshaft; a 2^{nd} order mass balance shaft operatively coupled to the crankshaft and rotatably driven by rotation of the crankshaft; and a mechanically driven charging mechanism attached to the combustion engine, the mechanically driven charging mechanism configured to provide pressurized air to the combustion engine; wherein the mechanically driven includes a compressor; wherein the compressor is attached to the 2^{nd} order mass balance shaft; and wherein the compressor is rotatably driven directly by the 2^{nd} order mass balance shaft.

In another aspect, a system for providing power to a vehicle is provided, the system comprising: a combustion engine having a cylinder and a piston coupled to a crankshaft; a mass balance shaft operatively coupled to the crankshaft and rotatably driven by rotation of the crankshaft; and a mechanically driven charging mechanism attached to the combustion engine, the charging mechanism configured to provide pressurized air to the combustion engine; wherein the charging mechanism is attached to the mass balance shaft; and wherein the charging mechanism is rotatably driven directly by the mass balance shaft.

In one aspect, the mass balance shaft is a 2^{nd} order mass balance shaft.

In one aspect, the charging mechanism includes a compressor, and the compressor is rotatably driven by the mass balance shaft.

In one aspect, the mass balance shaft extends parallel to the crankshaft and is radially offset from the crankshaft.

In one aspect, the mass balance shaft is disposed within the engine.

In one aspect, the mass balance shaft rotates at twice the speed of the crankshaft.

In one aspect, the mass balance shaft directly drives the mechanically driven charging mechanism.

In one aspect, the charging mechanism is a supercharger.

In one aspect, the mass balance shaft includes a first gear fixed for co-rotation therewith, and the crankshaft includes a second gear fixed for co-rotation therewith, wherein a circumference of the second gear is double the circumference of the first gear.

In one aspect, the second gear has a quantity of teeth that is double a quantity of teeth of the first gear.

In one aspect, the crankshaft is operatively coupled to a battery of an electric vehicle for charging the electric vehicle.

In another aspect, a method for providing power to a vehicle is provided, the method comprising the steps of: operating a combustion engine and rotating a crankshaft of the combustion engine; in response to rotating the crankshaft, rotating a 2^{nd} order mass balance shaft at a higher speed than the crankshaft; and in response to rotating the 2^{nd} order mass balance shaft, operating a compressor of a mechanically driven charging mechanism, wherein the compressor is attached to the 2^{nd} order mass balance shaft.

In one aspect, the step of rotating the 2^{nd} order mass balance shaft comprises rotating the 2^{nd} order mass balance shaft at twice the speed of the crankshaft.

In one aspect, the mechanically driven charging mechanism is supercharger, wherein the compressor operates at the same rotational speed as the 2^{nd} order mass balance shaft.

In one aspect, the 2^{nd} order mass balance shaft is attached to the crankshaft via a belt or chain, wherein rotation of the crankshaft drive the belt or chain, which rotates the 2^{nd} order mass balance shaft at the higher rotational speed.

In one aspect, the crankshaft includes a first gear fixed thereto and the mass balance shaft includes a second gear fixed thereto, wherein the belt or chain connects the first gear and the second gear for concurrent rotation, and wherein first gear is larger than the second gear.

In one aspect, the first gear has a first number of external teeth and the second gear has a second quantity of external teeth, wherein the first quantity of external teeth is twice that of the second quantity of external teeth.

In one aspect, the first gear has a circumference that is twice that of the second gear.

In one aspect, the engine includes at least one cylinder having a piston attached to the crankshaft, wherein actuation of the piston generates an inertial force, and wherein the 2^{nd} order mass balance shaft includes at least one eccentrically mounted weight attached thereto adapted to counteract the inertial force generated by the piston.

In one aspect, the method includes charging a battery of an electric vehicle via rotation of the crankshaft.

### BRIEF DESCRIPTION OF THE DRAWINGS

Other advantages of the present invention will be readily appreciated, as the same becomes better understood by reference to the following detailed description when considered in connection with the accompanying drawings wherein:

FIGS. 1 and 2 illustrate one aspect of a system for providing power to a vehicle, the system including a combustion engine, a 2^{nd} order mass balance shaft, and a mechanically driven charging mechanism, where a compressor of the mechanically driven charging mechanism is attached to the 2^{nd} order mass balance shaft; and

FIGS. 3A-3F illustrate multiple views of the system, showing the mechanically driven charging mechanism attached to the 2^{nd} order mass balance shaft and the 2^{nd} order mass balance shaft being rotatably driven by a crankshaft via a connecting chain or belt.

### DESCRIPTION OF THE ENABLING EMBODIMENT

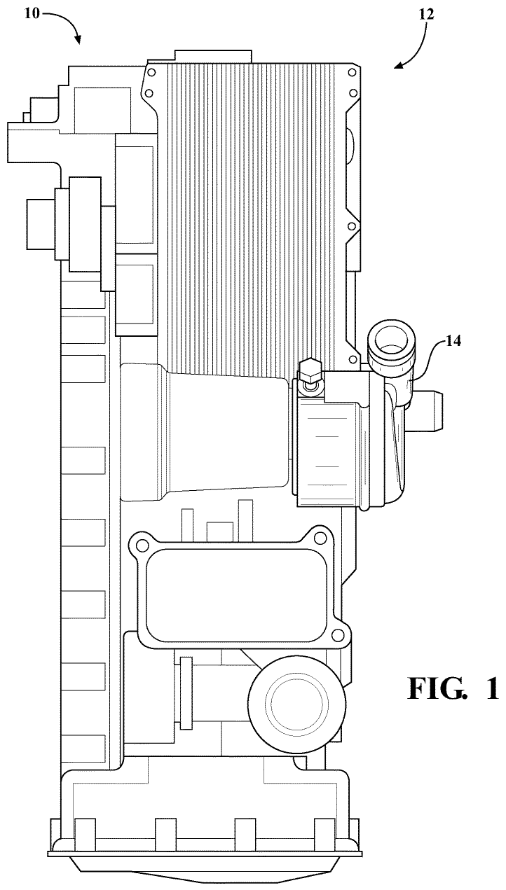

Referring to FIGS. 1-3, a system 10 for providing power to a vehicle, such as for driving the wheels of a serial hybrid vehicle, is provided. It will be appreciated that the present disclosure may also be applied to combustion engines used in non-hybrid applications.

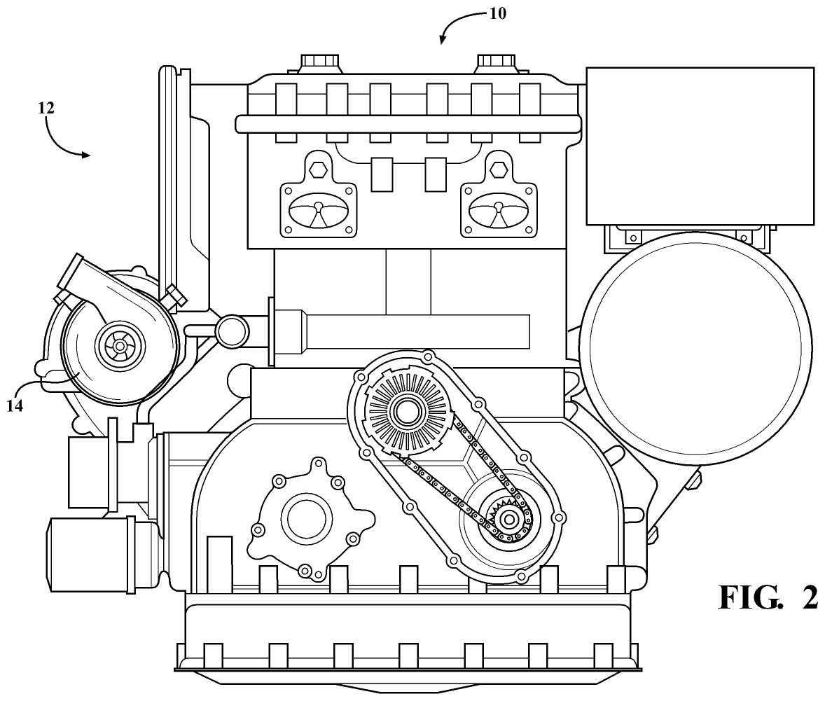

As shown in FIGS. 1 and 2, the system 10 includes a combustion engine 12, a charging mechanism 14, and a mass balancing system 16. The charging mechanism 14 may, in one aspect, be a flow compressor that is attached to the mass balancing system 16. The mass balancing system 16 may be in the form of a mass balancer shaft.

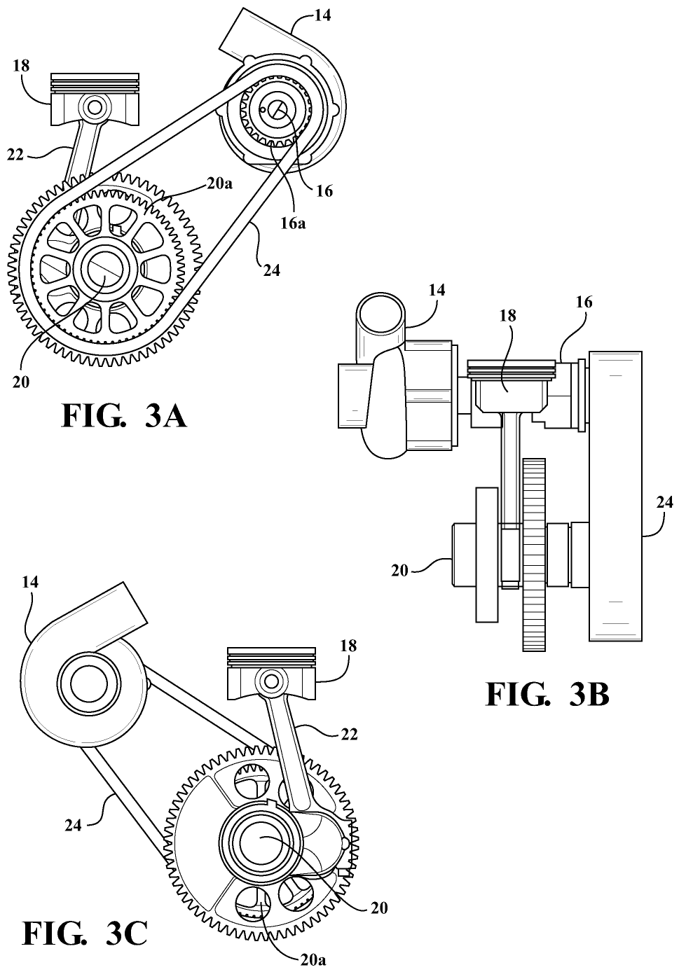

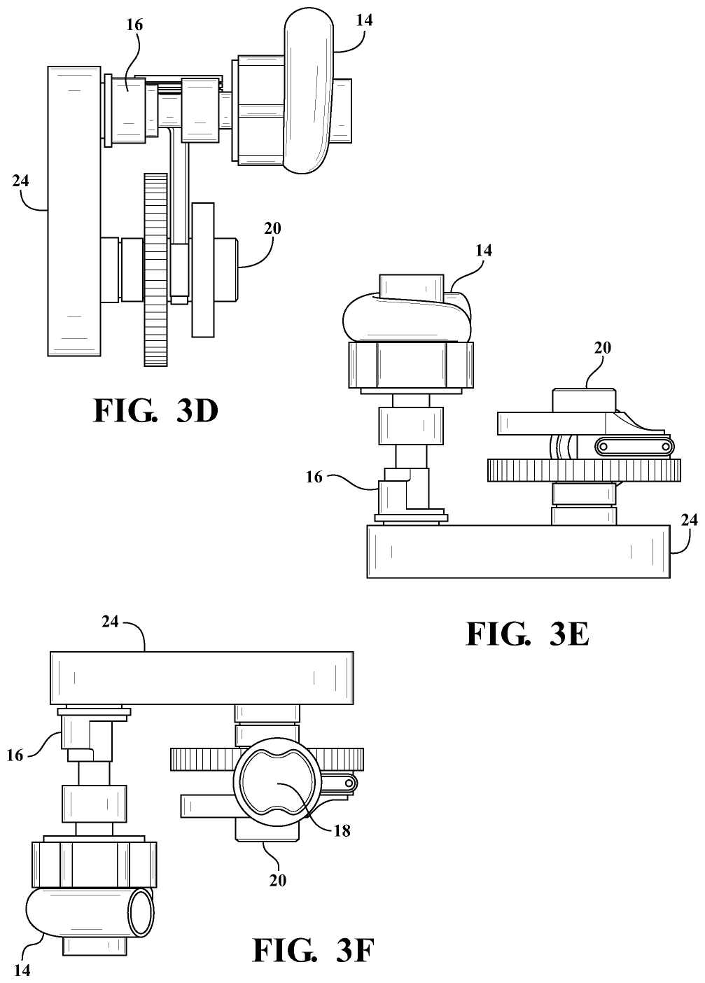

With reference to FIGS. 3A-3F, the combustion engine 12 may include one or more cylinders and corresponding pistons 18, which are connected to a crankshaft 20 via connecting rods 22. The combustion engine 12 may generally be any type of combustion engine and may be operated in a typical manner, in which fuel is introduced into the engine 12 and combusted to drive the pistons 18 and the crankshaft 20, thereby causing the crankshaft 20 to rotate at a given speed.

Various types of combustion engines may operate in a similar manner, and the differences between the various types of combustion engines need not be described in detail. Combustion engines may have various quantities and orientations of the cylinders that are actuated to drive the crankshaft. For example, the cylinders may be arranged in a V-shape or may be arranged in-line.

In one aspect, the engine 12 may be in the form of an engine having a low number of cylinders, such as one or two cylinders, which may be used as part of a serial hybrid vehicle. In one aspect, the engine 12 is arranged to provide power to an electric motor and/or battery of the serial hybrid vehicle. The electric motor and/or battery may provide the power to drive the wheels of the vehicle in this aspect. In one aspect, the crankshaft 20 may rotate to drive a rotor and generate power for use by the electric motor that may be stored by the battery. The electric motor may be operated, via power provided by the battery, to directly drive the wheels of the serial hybrid vehicle.

In one aspect, the engine 12 may be in the form of an engine supplying a specific power of more than 40 kW/L. Accordingly, the engine 12 may be operatively coupled to the charging mechanism 14, which may operate to increase the power of the engine to outputs meeting or exceeding 40 kW/L. It will be appreciated that engines supplying different amounts of power may also be used, with the charging mechanism 14 being configured to operate to increase the power of the engine 12 to outputs meeting or exceeding the desired power output.

In one aspect, the charging mechanism 14 may be a mechanically driven charging mechanism 14. Accordingly, the charging mechanism 14 may also be referred to as the mechanically driven charging mechanism 14 herein. The mechanically driven charging mechanism 14 may be in the form of a supercharger or a turbocharger that includes a mechanical driving component (such as a rotating shaft). The mechanically driven charging mechanism 14 may be in the form of a mechanism in which air is introduced into the mechanically driven charging mechanism 14 via an inlet and compressed by the charging mechanism 14 by a mechanically driven compressor. The air that is introduced into the compressor via the inlet is compressed and “charged” by the mechanically driven charging mechanism 14 inside the charging mechanism, with the charged air exiting the charging mechanism 14 and being fed into the engine 12 in a manner known in the art regarding mechanically driven charging mechanisms and combustion engines. The compressor of the charging mechanism 14 may be rotatably driven by a shaft, as further described below.

The air provided to the inlet of the charging mechanism 14 may be provided via exhaust gas provided via a fluid conduit, in one aspect. Air may be provided to the charging mechanism 14 for being compressed therein may also be provided in other ways. Compressed air exiting the charging mechanism 14 may be routed to an inlet portion of the combustion engine 12 via a fluid conduit extending from the outlet of the charging mechanism 14 to the inlet of the combustion engine 12.

With continued reference to FIGS. 3A-3F, as described above, the compressor of the charging mechanism 14 may be rotatably driven by a shaft. During operation of the engine 12, in particular the operation of the pistons 18 that rotatably drive the crankshaft 20, inertial forces build up due to the oscillations of the pistons 18. As the fuel is provided to the cylinder chambers inside of the combustion engine and ignited, the pistons 18 are driven downward away from the cylinder head, creating oscillations and inertial forces. Second order forces of inertia may result in NVH issues for the engine 12. To counter these second order forces, the system 10 includes the mass balancing system 16, which may also be referred to as the balance shaft 16 or 2^{nd} order mass balance shaft 16. Provision of the balance shaft 16 thereby reduces the NVH issues via rotation of the balance shaft 16. As further described below, the rotation of the balance shaft 16 may be used to mechanically drive the compressor of the charging mechanism 14.

The balance shaft 16 may be disposed within the engine 12, and may be driven to rotate at the twice the speed of the crankshaft 20. The balance shaft 16 may include a plurality of eccentric weights mounted thereto that, when the shaft 16 is rotated, will counteract the second order inertial forces caused by the reciprocal movement of the pistons 18. The weights may be specifically tailored and selected to counter the specific inertial forces that are generated by the particular type of engine. It will be appreciated that various types of engines may have different cylinder arrangements and may thereby generate different types of second order inertial forces during operation.

As shown in FIGS. 3A-3F, the balance shaft 16 may be operatively connected to the crankshaft 20 by a belt or chain 24 and thereby may be chain driven or belt driven from the rotation of the crankshaft 20, such that when the crankshaft 20 rotates at a first speed, the balance shaft 16 will rotate at a second speed that is twice the first speed. Accordingly, power generated by the engine 12 via the actuation of the cylinders 18 and corresponding rotation of the crankshaft 20 may be transferred to the balance shaft 16. It will be appreciated that various chain/belt arrangements or other connections may be used to arrive at the resulting second speed of the balance shaft 16 that is twice the first speed.

As shown in FIGS. 3A-3F, the balance shaft 16 is attached to a gear 16a, which may include external gear teeth or the like. The gear 16a is rotationally fixed to the balance shaft 16 such that they co-rotate and rotate at the same angular velocity. The crankshaft 20 is similarly fixed to a gear 20a having external teeth, such that the gear 20a and the shaft co-rotate at the same angular velocity. In one aspect, the number of external teeth of the gear 20a is two times as much as the number of teeth of the gear 16a, thereby resulting in a 2:1 gear ratio, where the balance shaft 16 rotates twice as fast as the crankshaft 20. In this aspect, the chain 24 is used to mesh with the teeth of the gears.

As described above, a belt 24 may be used in place of the chain 24. In such situations, external teeth may not be used, and the belt 24 may frictionally transfer rotation and power from the crankshaft 20 to the balance shaft 16, with the circumference of the crankshaft 20 that drives the belt 24 being twice as much as the circumference at the balance shaft 16, thereby causing the balance shaft 16 to rotate at twice the speed of the crankshaft to counteract the inertial forces.

The crankshaft 20 may include additional gears fixed thereto for rotationally driving other components of the vehicle that receive power from the rotating crankshaft.

As described above, the engine 12 may be charged by the mechanically driven charging mechanism 14 to provide the desired output power that is greater than the non-charged version of the engine 12. The mechanically driven charging mechanism 14 may be in the form of a pump that pumps air to a higher pressure, such as a flow or positive displacement pump. The pump includes the compressor, which is driven rotatably by the balance shaft 16.

In one aspect, the compressor of the mechanically driven charging mechanism 14 does not include a dedicated drive, such as being separately chain driven off the crankshaft, similar to the balance shaft 16. Instead, the compressor of the mechanically driven charging mechanism 14 may be driven by the balance shaft 16. As described above, the balance shaft 16 may be driven off the crankshaft 20 to rotate at a speed that is twice as much as the crankshaft 20.

Thus, the drive of the mechanical compressor of the mechanically driven charging mechanism 14 may be combined with the second order mass balance shaft 16, rather than being driven separately by another chain or belt coupled to the crankshaft 20. Accordingly, the number of components separately driven by the crankshaft 20 may be reduced. The compressor of the mechanically driven charging mechanism 14 may still be considered to be driven by the crankshaft 20, because the compressor is attached to the mass balance shaft 16, and the mass balance shaft 16 is driven by the crankshaft 20. Thus, the compressor of the mechanically driven charging mechanism 14 may be considered chain driven or belt driven when the balance shaft 16 is chain driven or belt driven.

Thus, in one aspect, the charging mechanism 14, and more particularly the compressor therein, may be driven directly by the rotation of the balance shaft 16, and may therefore be driven at the same rotational speed of the balance shaft that is twice the rotational speed of the crankshaft 20. Rotating the balance shaft 16 at twice the rotational speed of the crankshaft 20 counteracts the inertial forces to reduce NVH. However, the rotational speed of the compressor can vary relative to the rotational speed of the crankshaft 20, as the shaft rotating the compressor is not rotated at a specific speed to counteract the inertial forces.

Accordingly, depending on the desired rotational speed of the compressor, the compressor of the charging mechanism 14 may be driven at a different speed than the balance shaft 16. The rotational speed may be varied by using a gear reduction mechanism and a separate shaft, rather than directly driving the compressor with the balance shaft 16.

The mass balance shaft 16 therefore provides additional functionality relative to prior designs. The mass balance shaft 16 operates simultaneously to counter the second order inertial forces caused by the reciprocating pistons 18, while also driving the compressor of the mechanically driven charging mechanism 14.

Due to the mass balance shaft 16 being attached to the compressor of the mechanically driven charging mechanism 14, the mass balance shaft 16 also has an increased mean load. This increased mean load may also result in reduced noise. Additionally, with the compressor being attached to the mass balance shaft 16, the compressor provides air supported damping of speed irregularity that may otherwise be present in the mass balance shaft 16 of prior arrangements. Mean load may also be increased by coupling the mass balance shaft 16 to other components that may be driven by rotation of the mass balance shaft 16.

As described above, the mass balance shaft 16 is driven at a speed that is twice the speed of the crankshaft 20. Accordingly, the high speed of the mass balance shaft 16 provides for an efficient drive for the compressor of the mechanically driven charging mechanism 14. As described above, if an even higher rotational speed of the compressor of the charging mechanism 14 is desirable, the rotational speed may be further increased via gear reduction.

The above-described aspects therefore allow for package neutral integration of a mechanical compressor that is chain driven or belt driven. The above-described aspects also provide functional integration of the mechanical compressor with the mass balance shaft 16. The use of the mechanically driven charging mechanism 14 is an improvement over non-mechanically driven charging systems, such as exhaust driven compressors used in turbo chargers, which can suffer from low cyclic efficiency and fluctuation due to the low number of cylinders.

Additional advantages include reduced components, cost, weight, and package size.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

1. A system for providing power to a vehicle, the system comprising:
a combustion engine having a cylinder and a piston coupled to a crankshaft;
a mass balance shaft operatively coupled to the crankshaft and rotatably driven by rotation of the crankshaft; and
a mechanically driven charging mechanism attached to the combustion engine, the charging mechanism configured to provide pressurized air to the combustion engine;
wherein the charging mechanism is attached to the mass balance shaft; and
wherein the charging mechanism is rotatably driven directly by the mass balance shaft.

2. The system of claim 1, wherein the mass balance shaft is a 2^{nd} order mass balance shaft.

3. The system of claim 2, wherein the charging mechanism includes a compressor, and the compressor is rotatably driven by the mass balance shaft.

4. The system of claim 1, wherein the mass balance shaft extends parallel to the crankshaft and is radially offset from the crankshaft.

5. The system of claim 1, wherein the mass balance shaft is disposed within the engine.

6. The system of claim 1, wherein the mass balance shaft rotates at twice the speed of the crankshaft.

7. The system of claim 1, wherein the mass balance shaft directly drives the mechanically driven charging mechanism.

8. The system of claim 1, wherein the charging mechanism is a supercharger.

9. The system of claim 1, wherein the mass balance shaft includes a first gear fixed for co-rotation therewith, and the crankshaft includes a second gear fixed for co-rotation therewith, wherein a circumference of the second gear is double the circumference of the first gear.

10. The system of claim 9, wherein the second gear has a quantity of teeth that is double a quantity of teeth of the first gear.

11. The system of claim 1, wherein the crankshaft is operatively coupled to a battery of an electric vehicle for charging the electric vehicle.

12. A method for providing power to a vehicle, the method comprising the steps of:
operating a combustion engine and rotating a crankshaft of the combustion engine;
in response to rotating the crankshaft, rotating a 2^{nd} order mass balance shaft at a higher rotational speed than the crankshaft; and
in response to rotating the 2^{nd} order mass balance shaft, operating a compressor of a mechanically driven charging mechanism, wherein the compressor is attached to the 2^{nd} order mass balance shaft.

13. The method of claim 12, wherein the step of rotating the 2^{nd} order mass balance shaft comprises rotating the 2^{nd} order mass balance shaft at twice the speed of the crankshaft.

14. The method of claim 12, wherein the mechanically driven charging mechanism is supercharger, wherein the compressor operates at the same rotational speed as the 2^{nd} order mass balance shaft.

15. The method of claim 12, wherein the 2^{nd} order mass balance shaft is attached to the crankshaft via a belt or chain, wherein rotation of the crankshaft drive the belt or chain, which rotates the 2^{nd} order mass balance shaft at the higher rotational speed.

16. The method of claim 15, wherein the crankshaft includes a first gear fixed thereto and the mass balance shaft includes a second gear fixed thereto, wherein the belt or chain connects the first gear and the second gear for concurrent rotation, and wherein first gear is larger than the second gear.

17. The method of claim 16, wherein first gear has a first number of external teeth and the second gear has a second quantity of external teeth, wherein the first quantity of external teeth is twice that of the second quantity of external teeth.

18. The method of claim 16, wherein the first gear has a circumference that is twice that of the second gear.

19. The method of claim 12, wherein the engine includes at least one cylinder having a piston attached to the crankshaft, wherein actuation of the piston generates an inertial force, and wherein the 2^{nd} order mass balance shaft includes at least one eccentrically mounted weight attached thereto adapted to counteract the inertial force generated by the piston.

20. The method of claim 12, further comprising charging a battery of an electric vehicle via rotation of the crankshaft.
